(19) United States
(12) Patent Application Publication
(10) Pub. No.: US 2026/0166689 A1
(43) Pub. Date: Jun. 18, 2026

(54) NUT RUNNING TOOL

(71) Applicant: Milwaukee Electric Tool Corporation, Brookfield, WI (US)

(72) Inventor: Adam M. Schroeder, Brookfield, WI (US)

(21) Appl. No.: 19/405,769

(22) Filed: Dec. 2, 2025

Related U.S. Application Data
(60) Provisional application No. 63/734,326, filed on Dec. 16, 2024.

(51) Int. Cl. B25B 21/00

(52) U.S. Cl. CPC B25B 21/002

(57) ABSTRACT

A nut running tool includes a housing having first and second housing portions, a drive gear arranged between the housing portions, a first driven gear having a lobed portion and a geared portion meshed with the drive gear, and a second driven gear having a lobed portion and a geared portion meshed with the drive gear. The lobed portions are in selective communication with a nut to facilitate rotation of the nut via rotation of the lobed portions, with rotation of the lobed portion of the first driven gear being between 15 and 45 degrees out of phase with rotation of the lobed portion of the second driven gear.

### CROSS-REFERENCE TO RELATED APPLICATIONS

This application claims the benefit of U.S. Provisional Application No. 63/734,326, filed Dec. 16, 2024, which is hereby incorporated by reference in its entirety.

### BACKGROUND

In construction applications, an operator may need to run (e.g., move) a fastener (e.g., a nut) up or down a piece of threaded rod. For example, when hanging conduit or other wiring. However, typical systems and methods for running the fastener up or down the threaded rod involve manually rotating the fastener, which can be a time-consuming and labor-intensive process.

### SUMMARY

According to one aspect of the present disclosure, a nut running tool can include a housing having a first housing portion and a second housing portion. A drive gear can be arranged between the first housing portion and the second housing portion. A first driven gear can have a lobed portion and a geared portion, with the geared portion meshed with the drive gear for rotation therewith. A second driven gear can have a lobed portion and a geared portion, with the geared portion meshed with the drive gear for rotation therewith. The lobed portions of the first driven gear and the second driven gear can be in selective communication with a nut to facilitate rotation of the nut via rotation of the lobed portions of the first driven gear and the second driven gear, with rotation of the lobed portion of the first driven gear being between 15 and 45 degrees out of phase with rotation of the lobed portion of the second driven gear.

In some examples, rotation of the lobed portion of the first driven gear can be 30 degrees out of phase with rotation of the lobed portion of the second driven gear.

In some examples, the second housing portion can include a support ledge, with the support ledge in contact with a nut during rotation of the nut via the lobed portions of the first driven gear and the second driven gear.

In some examples, the first housing portion can include a support ledge, with the support ledge of the first housing portion and the support ledge of the second housing portion forming a slot to receive the nut during rotation of the nut via the lobed portions of the first driven gear and the second driven gear.

In some examples, the first housing portion can include a hook, with the hook surrounding a portion of a threaded rod during rotation of the nut via the lobed portions of the first driven gear and the second driven gear.

In some examples, the nut running tool can be powered via an internal power source, with the internal power source including a battery and a motor powered by the battery.

In some examples, the battery can be a removable, rechargeable lithium ion battery.

According to another aspect of the present disclosure, a nut running tool can include a housing. A drive gear can be positioned within the housing. A first driven gear and a second driven gear can be arranged in a substantially coplanar configuration with the drive gear. The first driven gear can have a first lobed portion and a first geared portion, with the first lobed portion defining one or more recesses and the first geared portion being meshed with the drive gear. The second driven gear can have a second lobed portion and a second geared portion, with the second lobed portion defining one or more recesses and the second geared portion being meshed with the drive gear. The first and second lobed portions can be configured to engage a nut such that a corner of the nut is consistently within one of the recesses of either the first driven gear or the second driven gear during rotation of the nut.

In some examples, the first lobed portion of the first driven gear can be about 30 degrees out of phase with the second lobed portion of the second driven gear.

In some examples, the first lobed portion and the second lobed portion can each include six lobes.

In some examples, the housing can include a first support ledge configured to contact the nut during rotation of the nut, with the first support ledge defining a cutout sized to receive a threaded rod.

In some examples, the housing can include a first housing portion and a second housing portion, and the first housing portion can include a second support ledge, with the first support ledge and the second support ledge forming a slot to receive the nut.

In some examples, the housing can include a hook configured to surround a portion of a threaded rod during rotation of the nut.

In some examples, an input shaft can be secured to the drive gear and can extend from the drive gear through the housing, with the input shaft being selectively connected to an external power source.

According to yet another aspect of the present disclosure, a method of moving a nut along a threaded rod using a nut running tool can include providing a nut running tool with a drive gear and first and second driven gears, with each driven gear having a lobed portion defining one or more recesses. The method can include positioning the nut running tool such that the lobed portions of the first and second driven gears engage a nut threaded on a threaded rod. The method can include rotating the drive gear in a first direction. The method can include causing the first and second driven gears to rotate in a second direction opposite to the first direction through meshing engagement with the drive gear. The method can include rotating the nut via contact between the lobed portions and the nut, with the first and second driven gears being timed out of phase such that a corner of the nut is consistently within a recess of either the first driven gear or the second driven gear during rotation of the nut.

In some examples, the first and second driven gears can be timed about 30 degrees out of phase with each other.

In some examples, positioning the nut running tool can include placing a support ledge of the nut running tool against a surface of the nut and inserting the threaded rod through a cutout defined in the support ledge.

In some examples, positioning the nut running tool can further include securing a hook of the nut running tool around a portion of the threaded rod to secure the tool to the threaded rod during rotation of the nut.

In some examples, rotating the drive gear can include connecting an external power source to an input shaft coupled to the drive gear and extending from the drive gear through a housing of the nut running tool.

In some examples, rotating the drive gear can include actuating a user interface positioned on the nut running tool and activating a motor powered by a battery to rotate the drive gear, with the motor, battery, and user interface being housed within the nut running tool.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a first axonometric view of a nut running tool according to aspects of the present disclosure.

FIG. 2 is a top view of the nut running tool of FIG. 1 with a first portion of the housing removed to show internal components.

FIG. 3 is an axonometric view of a drive member of the nut running tool of FIG. 1.

FIG. 4 is a bottom view of a drive system of the nut running tool of FIG. 1.

FIG. 5 is a second axonometric view of the nut running tool of FIG. 1 including a nut engaged with the tool.

FIG. 6 is a top view of the nut running tool of FIG. 1 including the nut of FIG. 5, with the first portion of the housing removed to show internal components.

FIG. 7 is a top view of the drive members of FIG. 3 engaged with the nut of FIG. 5.

FIG. 8 is diagrammatic view of another example of a nut running tool according to aspects of the present disclosure.

FIG. 9 is diagrammatic view of another example of a nut running tool according to aspects of the present disclosure, with the tool in a first position.

FIG. 10 is a diagrammatic view of the nut running tool of FIG. 9, with the tool in a second position.

FIG. 11 is a side view of yet another example of a nut running tool according to aspects of the present disclosure.

### DETAILED DESCRIPTION

The following discussion is presented to enable a person skilled in the art to make and use embodiments of the invention. Given the benefit of this disclosure, various modifications to the illustrated embodiments will be readily apparent to those skilled in the art, and the principles herein can be applied to other embodiments and applications without departing from embodiments of the invention. Thus, embodiments of the invention are not intended to be limited to embodiments shown, but are to be accorded the widest scope consistent with the principles and features disclosed herein.

As generally noted above, typical systems and methods for running (e.g., moving) a fastener (e.g., a nut) up or down a threaded rod involve manually rotating the fastener, which can be a time-consuming and labor-intensive process.

To mitigate these issues, the operator may utilize a nut running tool, which may include a drive gear and one or more driven gears. In some examples, the driven gears may include a lobed portion and a geared portion. The geared portion may be arranged in contact with the drive gear so that rotation of the drive gear imparts corresponding rotation in the driven gears. Further, the lobed portions of the driven gears may be configured to contact a fastener (e.g., a nut) so that rotation of the driven gears, via contact between the lobed portions and the nut may generate rotation of the nut.

Further, in some examples, to facilitate smooth rotation of the nut, the nut running tool may include two driven gears each having a lobed portion. In some examples, the lobed portions may be timed so that the lobed portion of the first driven gear is about 30 degrees out of phase with the lobed portion of the second driven gear. Thus, due to the offset timing of the driven gears, a corner of the nut may be consistently engaged with either the first driven gear or the second driven gear, which may facilitate consistent and smooth rotation of the nut and may efficiently drive the nut along a threaded rod, without the need for an operator to manually thread the nut.

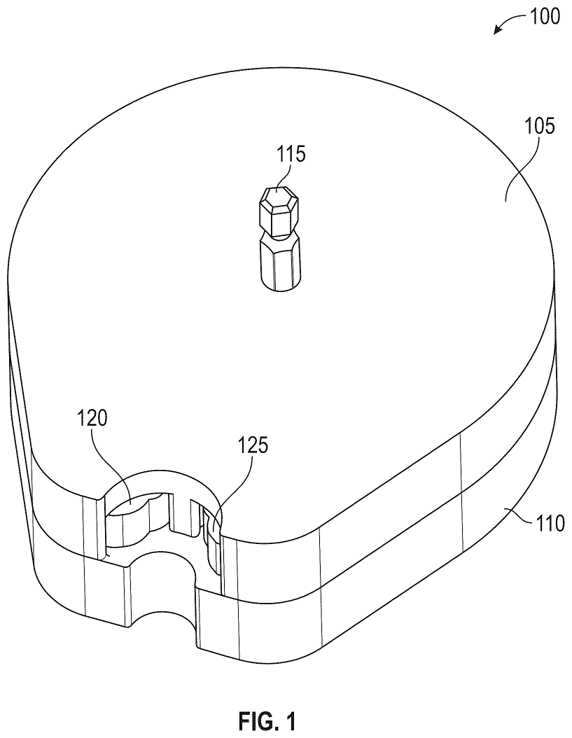

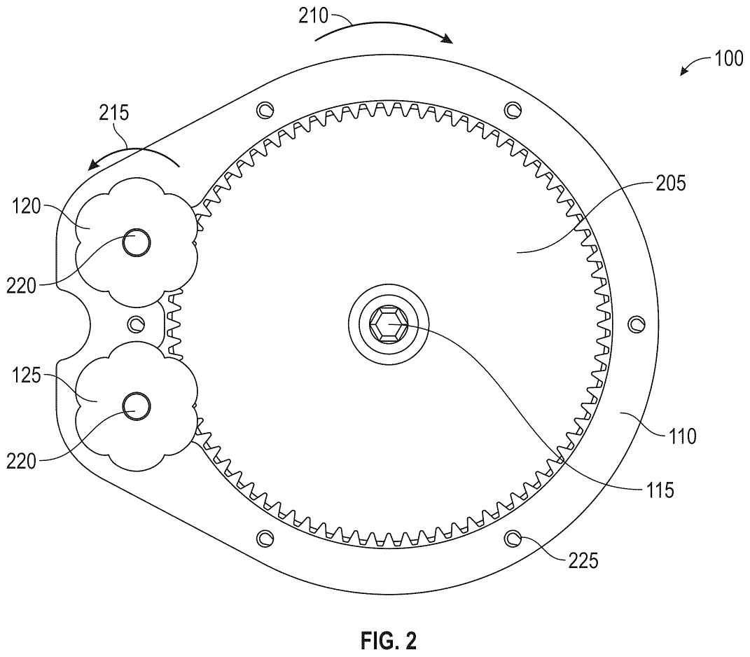

FIGS. 1 and 2 show an example of a tool 100 (e.g., a nut running tool). The tool 100 may be used by an operator to run (e.g., move, thread) a fastener (e.g., a nut, etc.) along (e.g., up, or down on) a piece of threaded rod or any other known threaded receptacle for the fastener. In some examples, the tool 100 may include a clamshell type housing having a first housing portion 105 and a second housing portion 110 secured together via one or more fasteners 225. In some examples, the first housing portion 105 and the second housing portion 110 may be hollow to permit the insertion of one or more internal components of the tool 100 between the first housing portion 105 and the second housing portion 110.

For example, internal components of the tool 100 may include a drive gear 205 configured to generate rotation in a first driven gear 120 and a second driven gear 125. The drive gear 205 serves as the primary power transmission component, receiving rotational input and distributing it to the driven gears through mechanical engagement. As shown in the figures, the drive gear 205 is positioned centrally within the housing assembly, with the first driven gear 120 and the second driven gear 125 arranged in a substantially coplanar configuration around the drive gear 205. This planar arrangement allows all three gears to operate within the same horizontal plane (e.g., formed by the drive gear), facilitating efficient meshing engagement while maintaining a compact overall tool profile.

In some examples, the first driven gear 120 and the second driven gear 125 may be secured to the second housing portion 110 via respective shafts 220, which may permit rotational movement of the first driven gear 120 and the second driven gear 125 about the shafts 220. These shafts 220 function as bearing surfaces and rotational axes, allowing the driven gears to rotate freely while maintaining their proper positioning relative to the drive gear 205 and the nut engagement area. The shaft mounting arrangement also provides structural support to handle the torque loads generated during nut running operations. In some examples, the first driven gear 120 and the second driven gear 125 may be driven by the drive gear 205 in order to permit movement of a nut along a threaded rod (e.g., via contact between the first driven gear 120, second driven gear 125, and the nut).

The mechanical advantage provided by the gear ratio between the drive gear 205 and the driven gears allows for efficient torque multiplication, enabling the tool to apply sufficient rotational force to overcome thread friction and move nuts smoothly along threaded rods. The spatial relationship between the gears creates a substantially triangular arrangement when viewed from above, with the drive gear 205 at one vertex and the two driven gears 120, 125 positioned at the other vertices, allowing simultaneous engagement of the nut (or other fastener) with both driven gears. Further, in some examples, in order to power rotation of the drive gear 205 (e.g., in the direction shown by arrow 210), an input shaft 115 may be secured to the drive gear 205. The input shaft 115 provides the interface between external power sources and the internal gear mechanism, transferring rotational energy from the power source into the tool.

In some examples, input shaft 115 may extend perpendicularly from the drive gear 205, through the first housing portion 105 of the tool 100. This perpendicular orientation allows for ergonomic operation while maintaining efficient power transmission, as the operator can apply the external power source at a convenient angle relative to the threaded rod and nut being operated upon. The input shaft 115 extends along an axis that is substantially perpendicular to the plane of gear rotation, creating a right-angle power transmission arrangement that facilitates tool maneuverability in confined spaces. In other examples, the input shaft 115 may extend from the drive gear in other orientations (e.g., parallel, offset, etc.). For example, the input shaft 115 may extend from the drive gear in line with the drive gear. However, in some examples, this configuration may require different gearing systems, such as bevel gears, worm gears, etc. In some examples, the input shaft 115 may be secured to a power tool (e.g., a drill, impact wrench, etc.) in order to provide powered rotation of the drive gear 205 (e.g., in order to power the tool 100). The compatibility with standard power tools provides versatility and convenience, allowing operators to use existing equipment rather than requiring specialized power sources.

In some examples, powered rotation of the drive gear 205 in the direction shown by arrow 210 may correspond to powered rotation of the first driven gear 120 and the second driven gear 125 in the direction shown by arrow 215 (e.g., in a direction opposite the direction of rotation of the arrow 215). The gear arrangement creates a mechanical relationship where the drive gear 205 and driven gears 120, 125 rotate in opposite directions due to their external meshing engagement, with the driven gears positioned on the same side of the drive gear 205 and therefore rotating in the same direction as each other.

As should be appreciated, in some examples, rotation of the drive gear 205 may be reversed (e.g., in a direction opposite that shown by arrow 210). This reversibility is achieved by changing the rotational direction of the external power source, such as activating a reverse function on a drill or impact wrench. Correspondingly, rotation of the first driven gear 120 and the second driven gear 125 may be reversed (e.g., in a direction opposite that shown by arrow 215). The ability to reverse the gear rotation provides bidirectional functionality, allowing the tool to both tighten and loosen nuts, or to move nuts in either direction along a threaded rod depending on the thread orientation. The coplanar gear arrangement ensures that this bidirectional capability is maintained regardless of rotation direction, with the mechanical advantage and gear ratios remaining consistent in both operational modes. Thus, a nut may be driven along a threaded rod in a first direction (e.g., upwards) when the drive gear 205 is rotated in the direction shown by arrow 210 and may be driven along the threaded rod in a second, opposite direction (e.g., downwards) when the drive gear 205 is rotated in the opposite direction of the direction shown by arrow 210. This bidirectional capability enhances the utility of the tool in construction and assembly applications, where nuts may need to be positioned at various locations along threaded rods or where different thread orientations (right-hand or left-hand threads) may be encountered. The directional control allows operators to efficiently position nuts for initial threading, move them to desired locations for final positioning, or remove them entirely when disassembly is required.

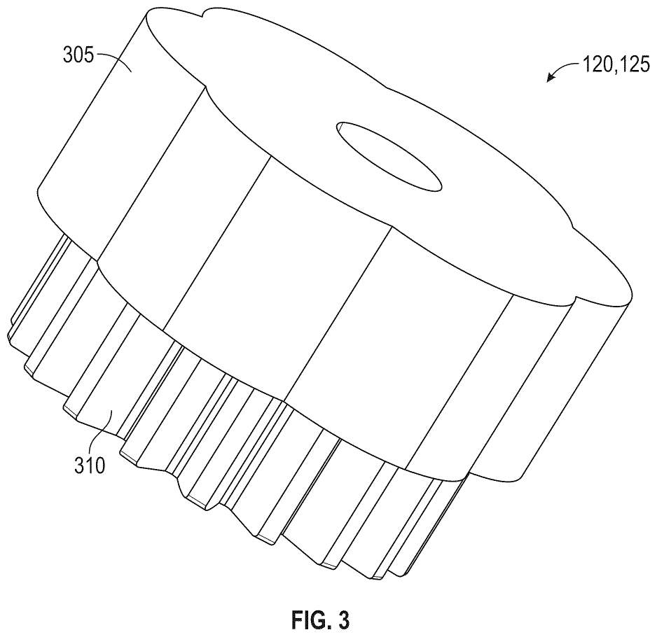

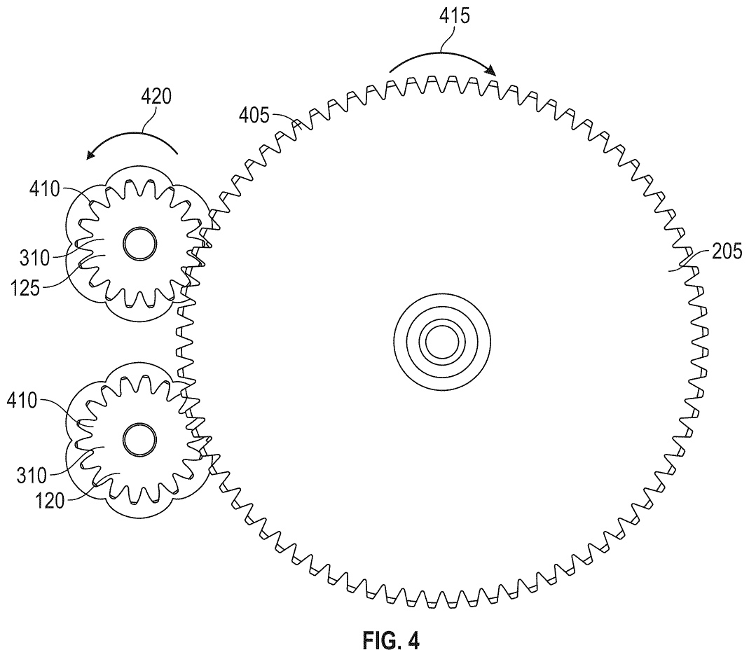

As illustrated in FIGS. 3 and 4, the first driven gear 120 and the second driven gear 125 of the tool 100 may each include a lobed portion 305 and a geared portion 310. In some examples, the lobed portion 305 may define a six-lobed clover shape, which may be configured to contact the fastener (e.g., nut) during rotation of the fastener. However, the first driven gear 120 and the second driven gear 125 may further include the geared portion 310 extending away from the lobed portion 305. In some examples, the geared portion 310 may define a series of teeth 410 configured to interlock with a series of teeth 405 extending from the drive gear 205. Thus, during rotation of the drive gear 205 in the direction shown by arrow 415, the teeth 405 of the drive gear 205 may interlock (e.g., mesh) with the teeth 410 of the geared portions 310 of both the first driven gear 120 and the second driven gear 125 and generate rotation of the first driven gear 120 and the second driven gear 125 (e.g., in the direction shown by arrow 420).

In some examples, the first driven gear 120 and the second driven gear 125 may be timed so that the lobes of the first driven gear 120 and the second driven gear 125 are out of sync with each other. For example, the first driven gear 120 and the second driven gear 125 may be timed so that the first driven gear 120 and the second driven gear 125 are about 30 degrees out of phase with each other. In other examples, the first driven gear 120 and the second driven gear 125 may be timed so that the first driven gear 120 and the second driven gear 125 are between 15 and 45 degrees, inclusive, out of phase with each other. In some examples, the first driven gear 120 and the second driven gear 125 may be timed out of phase so that the lobes of the first driven gear 120 and the second driven gear 125 contact the fastener (e.g., nut) at different points along the nut (e.g., the first driven gear 120 may contact a corner of the nut, while the second driven gear 125 contacts a flat of the nut). Due to this arrangement, smooth rotation of the fastener (e.g., nut) may be achieved as either the first driven gear 120 or the second driven gear 125 may be in constant contact with a corner of the fastener.

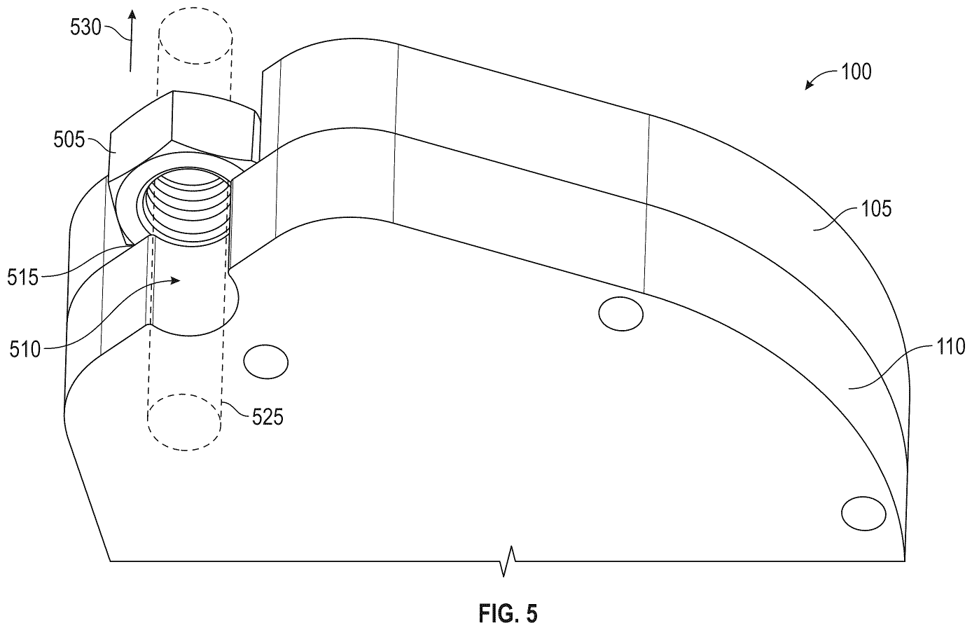

Turning now to FIGS. 5-7, various views of the tool 100 are shown with a nut 505 arranged within the tool 100 (e.g., for movement of the nut 505 along a threaded rod 525). Correspondingly, a process for using the tool 100 (e.g., to move the nut 505 along the threaded rod 525) will be described with respect to FIGS. 5-7. In some examples, in order to support the nut 505 during movement of the nut 505 along the threaded rod 525, the second housing portion 110 of the housing may define a support ledge 515. The support ledge 515 may define a cutout 510 sized to receive the threaded rod 525, but with a diameter smaller than a corresponding diameter of the nut 505. Thus, the threaded rod 525 may slot within the cutout 510, but the nut 505 may rest against the support ledge 515, which may permit an operator to apply a constant support (e.g., normal) force to the nut 505 during movement of the nut 505 along the threaded rod 525.

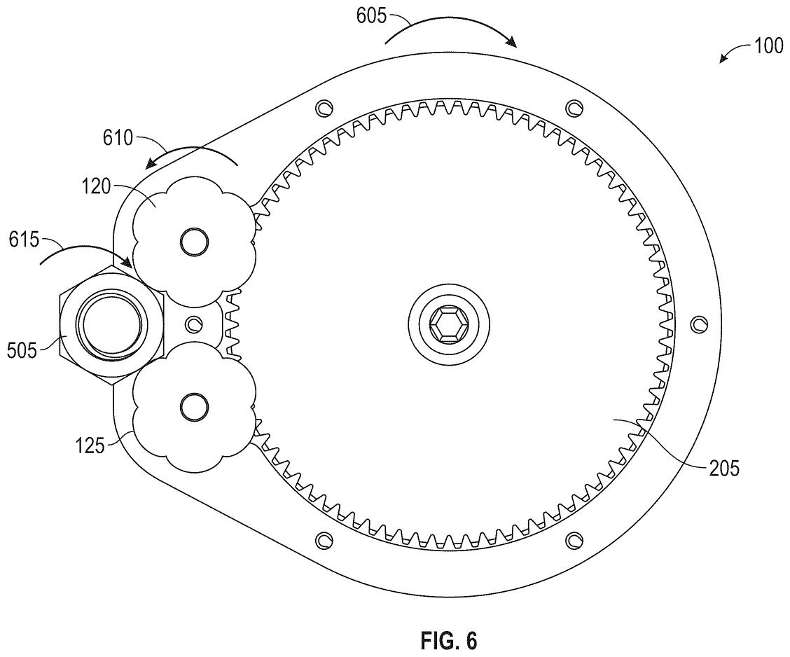

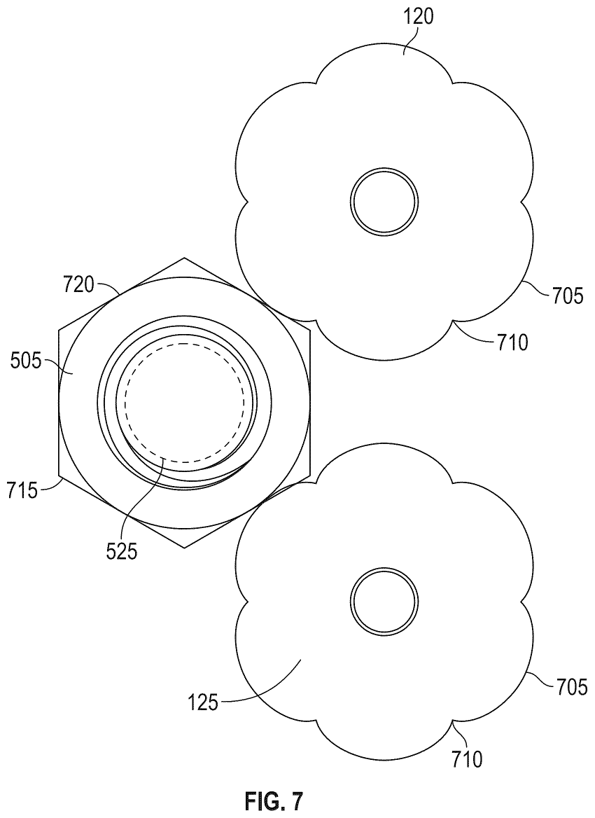

For example, if an operator desired to move the nut 505 along the threaded rod 525 in the direction shown by arrow 530, the operator may arrange the support ledge 515 against a lower surface of the nut 505 and arrange the threaded rod 525 within the cutout 510. The support ledge 515 provides a stable platform that maintains proper alignment between the tool 100 and the nut 505, ensuring consistent engagement throughout the threading operation. The cutout 510 is dimensioned to accommodate various standard threaded rod diameters while providing clearance for smooth movement of the tool along the length of the rod. Following this initial positioning, as shown in FIGS. 6 and 7, the nut 505 may be in contact with the first driven gear 120 and the second driven gear 125. The lobed portions 305 of both driven gears are positioned to simultaneously engage different surfaces of the hexagonal nut 505, creating multiple contact points that distribute the applied torque evenly. Thus, as the operator applies power to the tool 100 (e.g., via an external or internal power source of the tool 100), the drive gear 205 may begin to rotate in the direction shown by arrow 605. The power transmission occurs through the meshing engagement between the teeth 405 of the drive gear 205 and the teeth 410 of the geared portions 310 of both driven gears. Correspondingly, the first driven gear 120 and the second driven gear 125 may begin to rotate in the direction shown by arrow 610, which may generate rotation in the nut 505 in a direction shown by arrow 615 (e.g., in the same direction as the drive gear 205, opposite the direction of rotation of the first driven gear 120 and the second driven gear 125). This mechanical arrangement creates a gear reduction system that provides increased torque output while maintaining controlled rotational speed, allowing the tool to overcome thread friction and move nuts efficiently along threaded rods of varying lengths.

Further, during rotation of the nut 505, to permit consistent, smooth rotation of the nut 505 (e.g., without jumping, slipping, etc.) the first driven gear 120 and the second driven gear 125 may be arranged (e.g., timed) so that a corner 715 of the nut 505 is constantly within a recess 710 of either the first driven gear 120 or the second driven gear 125. For example, as mentioned previously, the first driven gear 120 and the second driven gear 125 may be about 30 degrees out of phase with each other. This angular offset is calculated based on the hexagonal geometry of standard nuts, where each corner is separated by 60 degrees, ensuring that the phase relationship between the driven gears facilitates engagement with the nut.

In some examples, the lobed portions 305 of the first driven gear 120 and the second driven gear 125 may each include a number of lobes 705 defining a series of recesses 710. The lobes 705 are shaped with curved profiles that complement the angular geometry of hexagonal nuts, while the recesses 710 are dimensioned to accommodate the corner radius and provide secure engagement without excessive clearance. The recesses 710 of the first driven gear 120 and the second driven gear 125 are configured to receive and capture the corners 715 of the nut 505 so that rotational force can be applied to the nut 505 from the first driven gear 120 and second driven gear 125. The depth and width of each recess 710 are optimized to provide sufficient engagement depth for reliable torque transmission while allowing easy insertion and removal of the nut during tool positioning.

In some examples, due to the offset timing of the first driven gear 120 and the second driven gear 125, as one of the corners 715 of the nut 505 is within one of the recesses 710 of the first driven gear 120, a flat 720 of the nut 505 may be in contact with one of the lobes 705 of the second driven gear 125. This alternating engagement pattern ensures that rotational force is continuously applied to the nut 505 throughout its complete rotation cycle, eliminating dead spots or periods of reduced engagement that could cause inconsistent movement. Put differently, when one of the corners 715 is within a recess 710 of one of the first driven gear 120 or second driven gear 125, the other of the first driven gear 120 or the second driven gear 125 may have a lobe 705 in contact with one of the flats 720 of the nut 505. The contact between a lobe 705 and a flat 720 provides a secondary engagement point that maintains rotational continuity while the primary corner-to-recess engagement transitions from one driven gear to the other. This dual-contact arrangement distributes the applied forces across multiple surfaces of the nut, reducing stress concentrations and minimizing wear on both the tool components and the fastener.

In some examples, during rotation of the first driven gear 120 and the second driven gear 125, one of the corners 715 of the nut 505 is consistently within one of the recesses 710 of the first driven gear 120 or the second driven gear 125, which facilitates consistent and smooth rotation of the nut 505. The synchronized rotation of both driven gears, combined with their phase-offset timing, creates a mechanical system that can accommodate variations in nut dimensions, thread tolerances, and rod alignment while maintaining reliable operation across a wide range of fastener sizes and thread pitches commonly encountered in construction and assembly applications.

In some examples, the lobed portion 305 of the first driven gear 120 and the second driven gear 125 may include six lobes 705. In other examples, the first driven gear 120 and the second driven gear 125 may include other numbers of lobes 705 (e.g., three, four, five, seven, eight, or any other number of lobes). Further, the number of lobes of the first driven gear 120 and the second driven gear 125 may be different. For example, the first driven gear 120 may include six lobes, while the second driven gear 125 may include five lobes.

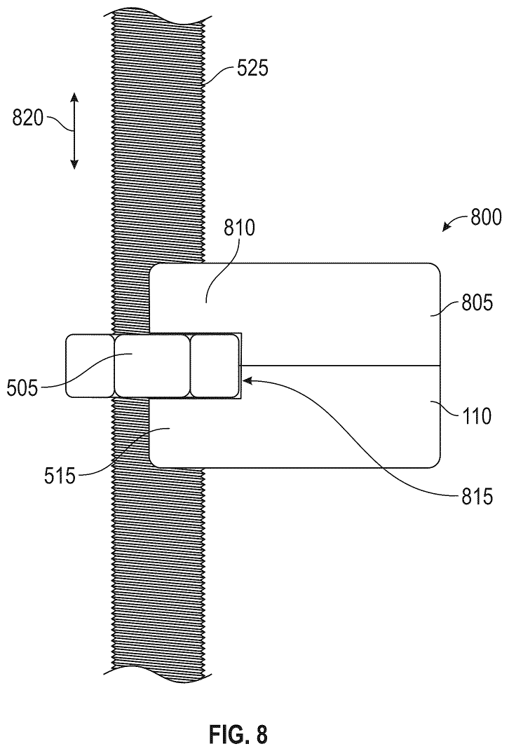

FIG. 8 illustrates another example of a nut running tool 800 that can be used to move a nut 505 along a threaded rod 525 (e.g., as an alternative configuration of the nut running tool 100). As will be recognized, the nut running tool 800 shares a number of components in common with and operates in a similar fashion to the examples illustrated and described previously. For the sake of brevity, these common features will not be again described below in detail. Rather, previous discussion of similarly named or numbered features, unless otherwise indicated, also applies to example configurations of the nut running tool 800.

In some examples, in addition to the support ledge 515 (e.g., a first support ledge) of the second housing portion 110, the first housing portion 805 of the nut running tool 800 may include a support ledge 810 (e.g., a second support ledge). The support ledge 810 may be shaped and function similarly to the support ledge 515 described previously (e.g., including a cutout 510 and a support ledge 515). Thus, in some examples, the support ledge 515 and the support ledge 810 together may define a slot 815 configured to receive and secure the nut 505 during movement of the nut 505 in the directions shown by arrows 820. As should be appreciated, due to the arrangement of the first support ledge 515 and the second support ledge 810 on either side of the nut 505, movement of the nut 505 in the directions shown by arrows 820 (e.g., up, and down the threaded rod 525) may be facilitated due to the contact between the first support ledge 515, second support ledge 810, and the nut 505.

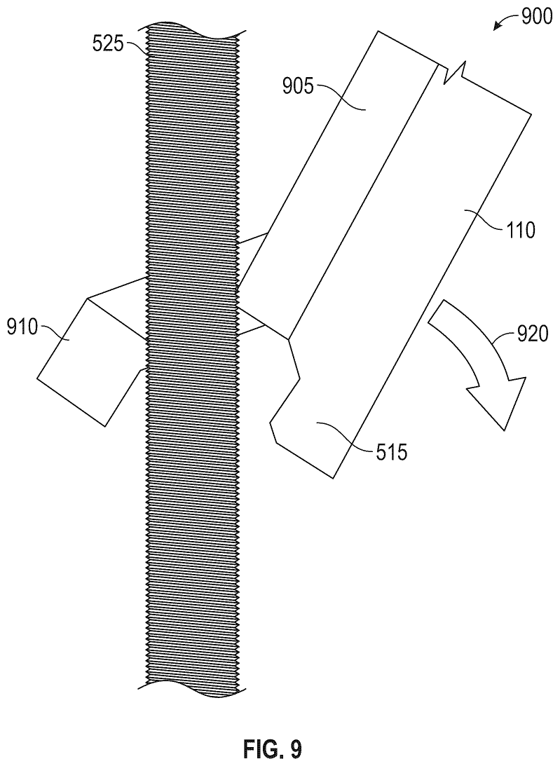

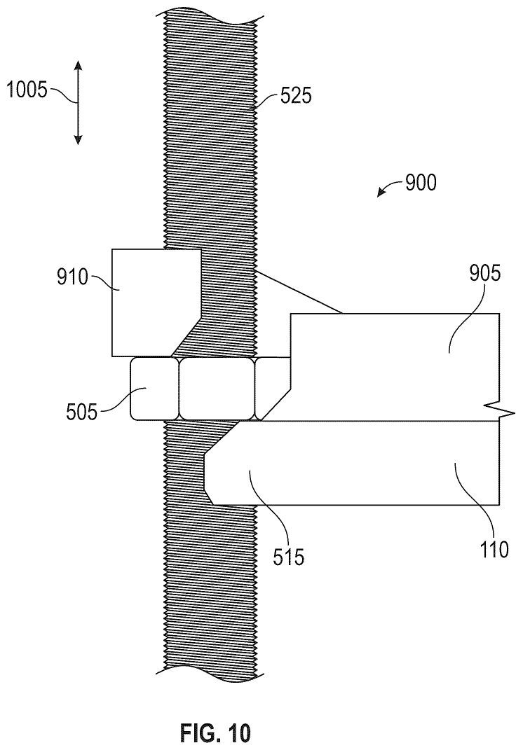

FIGS. 9 and 10 illustrate another example of a nut running tool 900 that can be used to move a nut 505 along a threaded rod 525 (e.g., as an alternative configuration of the nut running tool 100 and the nut running tool 800). As will be recognized, the nut running tool 900 shares a number of components in common with and operates in a similar fashion to the examples illustrated and described previously. For the sake of brevity, these common features will not be again described below in detail. Rather, previous discussion of similarly named or numbered features, unless otherwise indicated, also applies to example configurations of the nut running tool 900.

In some examples, in order to actively secure the nut running tool 900 to the threaded rod 525 during movement of the threaded rod 525 (e.g., in the direction shown by arrows 1005) the nut running tool 900 may include a first housing portion 905 defining a hook 910 (e.g., a hooked portion). The hook 910 may be configured to surround a portion of the threaded rod 525 so that contact between the nut 505 and the nut running tool 900 is achieved. Further, the operator may not need to provide additional force to the nut running tool 900 to maintain contact between the nut running tool 900 and the nut 505 during movement of the nut 505 along the threaded rod 525.

In some examples, in order to secure the nut running tool 900 to the threaded rod 525, a user may arrange the hook 910 around a portion of the threaded rod 525, with the nut running tool 900 at an angle with respect to the threaded rod 525 (see, e.g., FIG. 9). Following this, the operator may rotate the nut running tool 900 with respect to the threaded rod 525 (e.g., as shown by arrow 920) until the nut running tool 900 is substantially perpendicular to the threaded rod 525 and the nut 505 contacts the support ledge 515 (see, e.g., FIG. 10). In some examples, once the nut running tool 900 is arranged perpendicularly to the threaded rod 525, the nut 505 may be arranged between the hook 910 and the support ledge 515 so that movement of the nut 505 in the directions shown by arrows 1005 is facilitated.

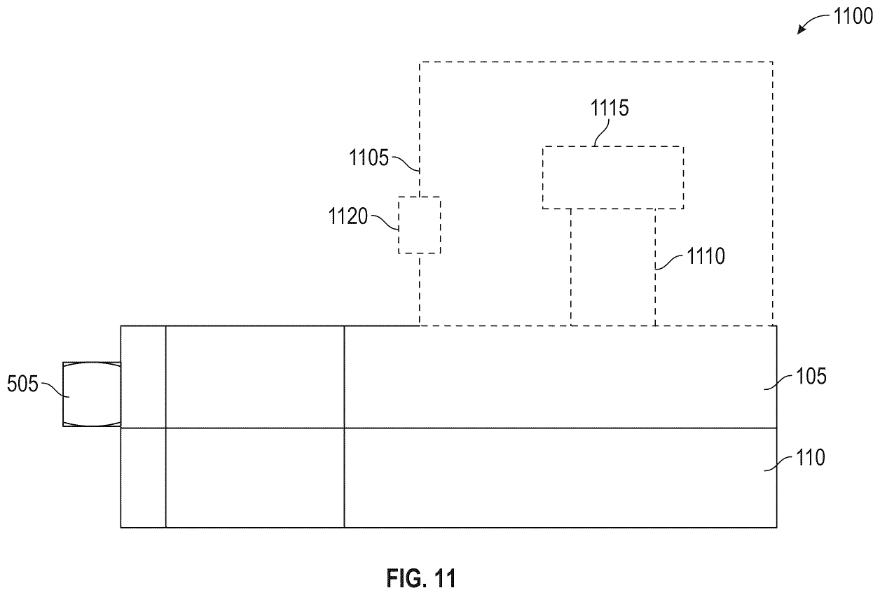

FIG. 11 illustrates another example of a nut running tool 1100 that can be used to move a nut 505 along a threaded rod 525 (e.g., as an alternative configuration of the nut running tool 100, nut running tool 800, nut running tool 900). As will be recognized, the nut running tool 1100 shares a number of components in common with and operates in a similar fashion to the examples illustrated and described previously. For the sake of brevity, these common features will not be again described below in detail. Rather, previous discussion of similarly named or numbered features, unless otherwise indicated, also applies to example configurations of the nut running tool 1100.

In some examples, rather than utilizing an external power source (e.g., drill connected to input shaft 115, etc.) to power the tool, the nut running tool 1100 may include an integrated power source. For example, the nut running tool 1100 may include a motor 1110 and a battery 1115. The motor 1110 provides direct rotational power to the drive gear 205, eliminating the need for external power tools and creating a self-contained, portable nut running system. This integrated approach enhances operator mobility and reduces the complexity of tool setup, as the operator no longer needs to manage separate power tools, extension cords, or compressed air lines. The motor 1110 may be an electric motor, such as a brushless DC motor, which provides efficient power conversion and extended operational life with minimal maintenance requirements. The motor 1110 may be directly coupled to the drive gear 205 through a shaft connection, or may include intermediate gearing to provide variable torque and speed characteristics for nut running applications.

In some examples, the battery 1115 may be a removable, rechargeable type battery (e.g., a lithium ion type battery, etc.). The removable design allows operators to carry spare batteries for extended work sessions and enables convenient charging without removing the tool from service. In some examples, the battery 1115 may provide power to the motor 1110 so that the motor 1110 may facilitate rotation of the drive gear 205 (e.g., the motor 1110 may be secured to the drive gear 205 via a shaft, etc.). The power transmission system may include electronic speed control circuitry that regulates motor output based on load conditions, ensuring consistent nut rotation speed regardless of thread friction or fastener resistance. This electronic control may also provide overload protection to prevent motor damage and extend component life. Further, in some examples, the motor 1110 and the battery 1115 may be arranged within a grip 1105 of the nut running tool 1100. The grip 1105 provides an ergonomic handle that allows comfortable single-handed operation while housing the power components in a balanced configuration. The grip design may incorporate textured surfaces or rubberized materials to enhance operator control and reduce fatigue during extended use. The internal arrangement of the motor 1110 and battery 1115 within the grip 1105 creates a balanced weight distribution that reduces operator strain and improves tool maneuverability in confined spaces.

In some examples, the grip 1105 may include a user interface 1120 (e.g., a button, etc.), which the operator may selectively actuate in order to operate the nut running tool 1100 (e.g., to actuate the nut 505). The user interface 1120 may include multiple control elements such as a variable-speed trigger that allows the operator to control rotation speed based on application requirements, a forward/reverse switch for bidirectional operation, and indicator lights that display battery charge level and operational status. The trigger mechanism may provide proportional speed control, allowing fine adjustment of nut rotation speed for precise positioning or high-speed running operations. Additional interface elements may include a safety lock-out switch to prevent accidental activation and a torque limiting feature that automatically stops motor operation when a predetermined resistance level is reached, preventing over-tightening or component damage.

In some implementations, devices or systems disclosed herein can be utilized, manufactured, or installed using methods embodying aspects of the invention. Correspondingly, any description herein of particular features, capabilities, or intended purposes of a device or system is generally intended to include disclosure of a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the invention, of the utilized features and implemented capabilities of such device or system.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

As used herein, unless otherwise defined or limited, directional terms are used for convenience of reference for discussion of particular figures or examples. For example, references to downward (or other) directions or top (or other) positions may be used to discuss aspects of a particular example or figure, but do not necessarily require similar orientation or geometry in all installations or configurations.

Also as used herein, unless otherwise limited or defined, “substantially parallel” indicates a direction that is within ±12 degrees of a reference direction (e.g., within ±6 degrees), inclusive.

Also as used herein, unless otherwise limited or defined, “substantially perpendicular” indicates a direction that is within ±12 degrees of perpendicular a reference direction (e.g., within ±6 degrees), inclusive.

Also as used herein, unless otherwise limited or defined, “integral” and derivatives thereof (e.g., “integrally”) describe elements that are manufactured as a single piece without fasteners, adhesive, or the like to secure separate components together. For example, an element stamped, cast, or otherwise molded as a single-piece component from a single piece of sheet metal or using a single mold, without rivets, screws, or adhesive to hold separately formed pieces together is an integral (and integrally formed) element. In contrast, an element formed from multiple pieces that are separately formed initially then later connected together, is not an integral (or integrally formed) element.

Additionally, unless otherwise specified or limited, the terms “about” and “approximately,” as used herein with respect to a reference value, refer to variations from the reference value of ±15% or less, inclusive of the endpoints of the range. Similarly, the term “substantially equal” (and the like) as used herein with respect to a reference value refers to variations from the reference value of less than ±10%, inclusive. Where specified, “substantially” can indicate in particular a variation in one numerical direction relative to a reference value. For example, “substantially less” than a reference value (and the like) indicates a value that is reduced from the reference value by 10% or more, and “substantially more” than a reference value (and the like) indicates a value that is increased from the reference value by 10% or more.

Also as used herein, unless otherwise limited or specified, “substantially identical” refers to two or more components or systems that are manufactured or used according to the same process and specification, with variation between the components or systems that are within the limitations of acceptable tolerances for the relevant process and specification. For example, two components can be considered to be substantially identical if the components are manufactured according to the same standardized manufacturing steps, with the same materials, and within the same acceptable dimensional tolerances (e.g., as specified for a particular process or product).

Unless otherwise specifically indicated, ordinal numbers are used herein for convenience of reference, based generally on the order in which particular components are presented in the relevant part of the disclosure. In this regard, for example, designations such as “first,” “second,” etc., generally indicate only the order in which a thus-labeled component is introduced for discussion and generally do not indicate or require a particular spatial, functional, temporal, or structural primacy or order.

The above detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

It is to be understood that the invention is not limited in its application to the details of construction and the arrangement of components set forth in the above description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The previous description of the disclosed embodiments is provided to enable any person skilled in the art to make or use the invention. Given the benefit of this disclosure, various modifications to these embodiments will be readily apparent to those skilled in the art, and the principles defined herein may be applied to other embodiments without departing from the spirit or scope of the invention. Thus, the invention is not intended to be limited to the embodiments shown herein but is to be accorded the widest scope consistent with the principles and novel features disclosed herein.

1. A nut running tool, comprising:
a housing having a first housing portion and a second housing portion;
a drive gear arranged between the first housing portion and the second housing portion;
a first driven gear having a lobed portion and a geared portion, the geared portion meshed with the drive gear for rotation therewith;
a second driven gear having a lobed portion and a geared portion, the geared portion meshed with the drive gear for rotation therewith; and
the lobed portions of the first driven gear and the second driven gear in selective communication with a nut to facilitate rotation of the nut via rotation of the lobed portions of the first driven gear and the second driven gear, rotation of the lobed portion of the first driven gear being between 15 and 45 degrees out of phase with rotation of the lobed portion of the second driven gear.

2. The nut running tool of claim 1, wherein rotation of the lobed portion of the first driven gear is 30 degrees out of phase with rotation of the lobed portion of the second driven gear.

3. The nut running tool of claim 1, wherein the second housing portion includes a support ledge, the support ledge in contact with a nut during rotation of the nut via the lobed portions of the first driven gear and the second driven gear.

4. The nut running tool of claim 3, wherein the first housing portion includes a support ledge, the support ledge of the first housing portion and the support ledge of the second housing portion forming a slot to receive the nut during rotation of the nut via the lobed portions of the first driven gear and the second driven gear.

5. The nut running tool of claim 3, wherein the first housing portion includes a hook, the hook surrounding a portion of a threaded rod during rotation of the nut via the lobed portions of the first driven gear and the second driven gear.

6. The nut running tool of claim 1, wherein the nut running tool is powered via an internal power source, the internal power source including a battery and a motor powered by the battery.

7. The nut running tool of claim 6, wherein the battery is a removable, rechargeable lithium ion battery.

8. A nut running tool, comprising:
a housing;
a drive gear positioned within the housing; and
a first driven gear and a second driven gear arranged in a substantially coplanar configuration with the drive gear;
the first driven gear having a first lobed portion and a first geared portion, the first lobed portion defining one or more recesses and the first geared portion being meshed with the drive gear;
the second driven gear having a second lobed portion and a second geared portion, the second lobed portion defining one or more recesses and the second geared portion being meshed with the drive gear; and
the first and second lobed portions being configured to engage a nut such that a corner of the nut is consistently within one of the recesses of either the first driven gear or the second driven gear during rotation of the nut.

9. The nut running tool of claim 8, wherein the first lobed portion of the first driven gear is about 30 degrees out of phase with the second lobed portion of the second driven gear.

10. The nut running tool of claim 8, wherein the first lobed portion and the second lobed portion each include six lobes.

11. The nut running tool of claim 8, wherein the housing includes a first support ledge configured to contact the nut during rotation of the nut, the first support ledge defining a cutout sized to receive a threaded rod.

12. The nut running tool of claim 11, wherein the housing includes a first housing portion and a second housing portion, and wherein the first housing portion includes a second support ledge, the first support ledge and the second support ledge forming a slot to receive the nut.

13. The nut running tool of claim 11, wherein the housing includes a hook configured to surround a portion of a threaded rod during rotation of the nut.

14. The nut running tool of claim 8, further comprising:
an input shaft secured to the drive gear and extending from the drive gear through the housing, the input shaft being selectively connected to an external power source.

15. A method of moving a nut along a threaded rod using a nut running tool, the method comprising:
providing a nut running tool with a drive gear and first and second driven gears, each driven gear having a lobed portion defining one or more recesses;
positioning the nut running tool such that the lobed portions of the first and second driven gears engage a nut threaded on a threaded rod;
rotating the drive gear in a first direction;
causing the first and second driven gears to rotate in a second direction opposite to the first direction through meshing engagement with the drive gear; and
rotating the nut via contact between the lobed portions and the nut, the first and second driven gears being timed out of phase such that a corner of the nut is consistently within a recess of either the first driven gear or the second driven gear during rotation of the nut.

16. The method of claim 15, wherein the first and second driven gears are timed about 30 degrees out of phase with each other.

17. The method of claim 15, wherein positioning the nut running tool includes:
placing a support ledge of the nut running tool against a surface of the nut; and
inserting the threaded rod through a cutout defined in the support ledge.

18. The method of claim 17, wherein positioning the nut running tool further includes:
securing a hook of the nut running tool around a portion of the threaded rod to secure the tool to the threaded rod during rotation of the nut.

19. The method of claim 15, wherein rotating the drive gear includes:
connecting an external power source to an input shaft coupled to the drive gear and extending from the drive gear through a housing of the nut running tool.

20. The method of claim 15, wherein rotating the drive gear includes:
actuating a user interface positioned on the nut running tool; and
activating a motor powered by a battery to rotate the drive gear, the motor, battery, and user interface being housed within the nut running tool.
